(19) United States
(12) Patent Application Publication
(10) Pub. No.: US 2020/0044497 A1
(43) Pub. Date: Feb. 6, 2020

(54) ELECTRIC MOTOR

(71) Applicant: GM GLOBAL TECHNOLOGY OPERATIONS LLC, Detroit, MI (US)

(72) Inventors: Mohammad F. Momen, Rochester Hills, MI (US); Khwaja M. Rahman, Troy (US)

(21) Appl. No.: 16/055,412

(22) Filed: Aug. 6, 2018

(51) Int. Cl. H02K 1/16; H02K 21/14; H02K 3/12; H02K 3/34; H02K 29/03; H02K 7/00

(52) U.S. Cl. CPC H02K 1/16; H02K 21/145; H02K 3/12; H02K 2213/03; H02K 29/03; H02K 7/006; H02K 3/34

(57) ABSTRACT

A rotating electric machine includes a stator and a rotor disposed within the stator. The stator defines a plurality of teeth and a plurality of semi-open slots. The plurality of semi-open slots further include a plurality of slot groups wherein each slot group further includes a plurality of slot subgroups. Each slot group includes at least a first subgroup of slots having a first slot opening width and being dedicated to a first phase, and a second subgroup of slots having a second slot opening width and being dedicated to a second phase, the second slot opening width being different from the first slot opening width.

### TECHNICAL FIELD

The present disclosure relates to a rotating electric machine used in traveling drive of an electrically driven vehicle such as an HEV or an EV, particularly a rotating electric machine which attenuates noise and vibration at the stator.

### BACKGROUND

Recently, attention is focused on hybrid vehicles and electric vehicles as vehicles taking into account environmental issues. A hybrid vehicle includes, in addition to a conventional engine, a direct current power source, an inverter, and a rotating electric machine (motor) driven by the inverter. In addition to achieving the power source by driving the engine, the direct current voltage from the direct current power source is converted into alternating voltage by the inverter, and the converted alternating voltage is used to rotate the motor to achieve power.

An electric vehicle includes a direct current power source, an inverter, and a motor driven by the inverter as the power source. In such a hybrid vehicle or electric vehicle, the motor is driven in a relatively wide range of rotation from low speed to high speed. Electromagnetic noise generated during driving has the potential to become so great that the rider in the vehicle will be disturbed by the noise. Particularly, the electromagnetic noise of harmonics in the range from an idling state where the engine rotational speed is low to the cruising region is humanly audible as annoying noise, differing in frequency from the ground noise caused by the engine and auxiliary machine. Such noise and vibration issues are evident where the stator windings do not overlap given that the radial force distribution in such machines contains low order harmonics which leads to a higher vibration level. Open slots may be used in such machines as shown for manufacturability reasons. However, flux density may be distorted when slots are used, and therefore, new spatial harmonics are generated due to the slotting. The radial magnetic forces are the main excitation for the magnetic vibration. Moreover, it has become apparent that this electromagnetic noise of harmonics is greatly affected by the electromagnetic excitation of 6f generated during motor operation. This “6f” implies six times the basic frequency f of the alternating current supplied to the motor.

Therefore, it is desirable to reduce the noise and vibration in an electric motor due to the radial magnetic forces at the stator.

### SUMMARY

The present disclosure provides an electric machine which attenuates noise and vibration from the stator. The electric machine includes a stator and a rotor disposed within the stator. The stator defines a plurality of teeth and a plurality of semi-open slots. The plurality of semi-open slots further is formed by plurality of slot groups wherein each slot group further includes a plurality of slot subgroups. Each slot group includes at least a first subgroup of slots having a first slot opening width and being dedicated to a first phase, and a second subgroup of slots having a second slot opening width and being dedicated to a second phase, the second slot opening width being different from the first slot opening width. The second subgroup of slots may be disposed adjacent to the first subgroup of slots. Each first slot opening width in the first slot subgroup may vary from each second slot opening width in the second subgroup by as little as 0.05 mm to as much as 0.5 mm. The first opening width is defined between a pair of first subgroup tooth tips which partially extend over a first subgroup slot opening, and the second opening width is defined between a pair of second subgroup tooth tips which partially extend over a second subgroup slot opening.

In the event the rotating electric machine is a three-phase motor, each slot group defined in the stator may further include a third subgroup of slots adjacent to the second subgroup of slots wherein each slot in the third subgroup of slots has a third slot opening width. The third slot opening width is defined between a pair of third subgroup tooth tips which partially extend over a third subgroup slot opening. The third slot opening width is different from each of the first and second slot opening widths. Therefore, the first slot opening width, the second slot opening width and the third slot opening width may vary from each other by as little as 0.05 mm to as much as 0.5 mm.

Noting that the electric machine of the present disclosure may have any number of phases, it is understood that regardless of the number of phases each tooth in the plurality of teeth defines a pair of tooth tips wherein each tooth tip extends over an adjacent corresponding slot. Moreover, the plurality of slot groups is formed along an inner circumference of the stator. Each slot group in the plurality of slot groups is configured to support a plurality of phase windings.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a schematic diagram showing the structure of a hybrid electric vehicle having rotating electric machines according to the present disclosure.

FIG. 2 is a front view of a non-limiting, example stator according to the present disclosure,

FIG. 3 is a schematic top view of the stator in FIG. 2.

FIG. 4 is an enlarged view of the stator slots in FIG. 3.

FIG. 5A is an enlarged view of stator teeth, tooth tips, and slots for any given slot subgroup in the present disclosure.

FIG. 5B is an enlarged view of the slot openings and slot opening widths for a slot group according to the present disclosure.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the lifter body 14 of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

The terms “upper” and “lower” may be used with respect to regions of a single component and are intended to broadly indicate regions relative to each other wherein the “upper” region and “lower” region together form a single component. The terms should not be construed to solely refer to vertical distance/height.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

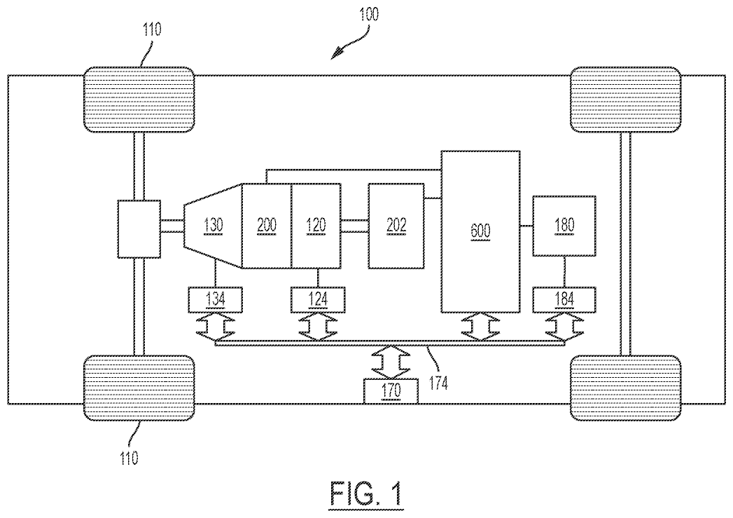

FIG. 1 is a schematic illustration showing the structure of a hybrid type electric vehicle having installed therein rotating electric machines achieved in an embodiment. An engine 120, a first rotating electric machine 200, a second rotating electric machine 202 and a battery 180 are mounted at a vehicle 100. When a drive force generated via the rotating electric machines 200 and 202 is needed, the battery 180 provides DC power to a power conversion device (inverter device) 600 engaged in drive of the rotating electric machines 200 and 202, and the power conversion device 600 converts the DC power supplied thereto to AC power which is then provided to the rotating electric machines 200 and 202 individually. During a regenerative traveling operation, on the other hand, the rotating electric machines 200 and 202 generate AC power by using the kinetic energy imparted by the vehicle and provide the AC power thus generated to the power conversion device 600. The power conversion device 600 then converts the AC power to DC power and provides the DC power to the battery 180. In addition, although not shown, a battery that provides low-voltage power (e.g., 14 V power) is installed in the vehicle so as to supply constant-voltage DC power to the control circuits to be described below.

Rotational torque generated via the engine 120 and the rotating electric machines 200 and 202 is transmitted to front wheels 110 via a transmission 130 and a differential gear unit 132. The transmission 130 is controlled by a transmission control device 134, whereas the engine 120 is controlled by an engine control device 124. The battery 180 is controlled by a battery control device 184. The transmission control device 134, the engine control device 124, the battery control device 184, the power conversion device 600 and an integrated control device 170 are connected with one another via a communication line 174.

The integrated control device 170 receives, via the communication line 174, information originating from the transmission control device 134, the engine control device 124, the power conversion device 600 and the battery control device 184, indicating the statuses at the individual control devices which are lower-order control devices relative to the integrated control device 170. Based upon the information thus received, the integrated control device 170 generates, through arithmetic operation, a control command for each corresponding control device. The control command generated through the arithmetic operation is then transmitted to the particular control device via the communication line 174.

The high-voltage battery 180, constituted with secondary battery cells such as lithium ion battery cells or nickel hydride battery cells, is capable of outputting high-voltage DC power in a range of 250 to 600 V or higher. The battery control device 184 outputs, via the communication line 174, information indicating the state of discharge in the battery 180 and the states of the individual battery cell units constituting the battery 180 to the integrated control device 170.

Upon judging, based upon the information provided by the battery control device 184, that the battery 180 needs to be charged, the integrated control device 170 issues a power generation operation instruction for the power conversion device 600. The primary functions of the integrated control device 170 further include management of torque output from the engine 120 and the rotating electric machines 200 and 202, arithmetic processing executed to calculate the overall torque, representing the sum of the torque output from the engine 120 and the torques output from the rotating electric machines 200 and 202, and to calculate a torque distribution ratio, and transmission of control commands generated based upon the arithmetic processing results to the transmission control device 134, the engine control device 124 and the power conversion device 600. Based upon a torque command issued by the integrated control device 170, the power conversion device 600 controls the rotating electric machines 200 and 202 so as to output torque or generate power as indicated in the command.

The power conversion device 600 includes power semiconductors that constitute inverters via which the rotating electric machines 200 and 202 are engaged in operation. The power conversion device 600 controls switching operation of the power semiconductors based upon a command issued by the integrated control device 170. As the power semiconductors are engaged in the switching operation as described above, the rotating electric machines 200 and 202 are each driven to operate as an electric motor or as a power generator.

When engaging the rotating electric machines 200 and 202 in operation as electric motors, DC power provided from the high-voltage battery 180 is supplied to DC terminals of the inverters in the power conversion device 600. The power conversion device 600 controls the switching operation of the power semiconductors so as to convert the DC power supplied to the inverters to three-phase AC power and provide the three-phase AC power to the rotating electric machines 200 and 202. When engaging the rotating electric machines 200 and 202 in operation as generators, the rotors of the rotating electric machines 200 and 202 are rotationally driven with a rotational torque applied thereto from the outside and thus, three-phase AC power is generated at the stator windings of the rotating electric machines 200 and 202. The three-phase AC power thus generated is converted to DC power in the power conversion device 600 and the high-voltage battery 180 is charged with the DC power supplied thereto.

It is to be noted that the rotating electric machine 200 and the rotating electric machine 202 are controlled independently of each other. For instance, when the rotating electric machine 200 is engaged in operation as an electric motor, the rotating electric machine 202 may operate as a motor or as a generator, or it may remain in an operation OFF state. This principle obviously applies to the rotating electric machine 200 as well. The integrated control device 170 determines a specific mode in which the rotating electric machine 200 and the rotating electric machine 202 are to be engaged in operation and issues a command for the power conversion device 600 accordingly. Based upon this command, the power conversion device 600 enters a motor operation mode, a generator operation mode or an operation OFF mode.

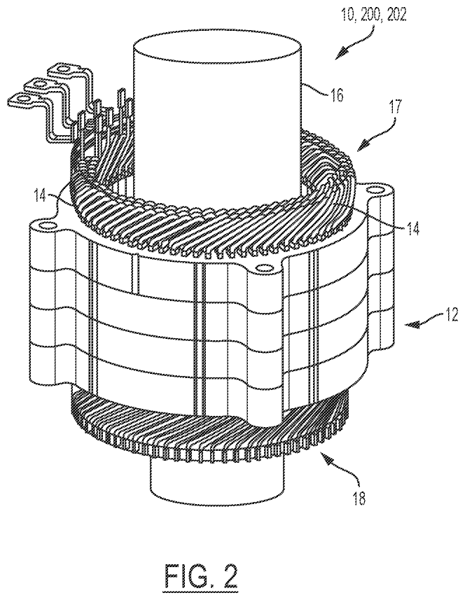

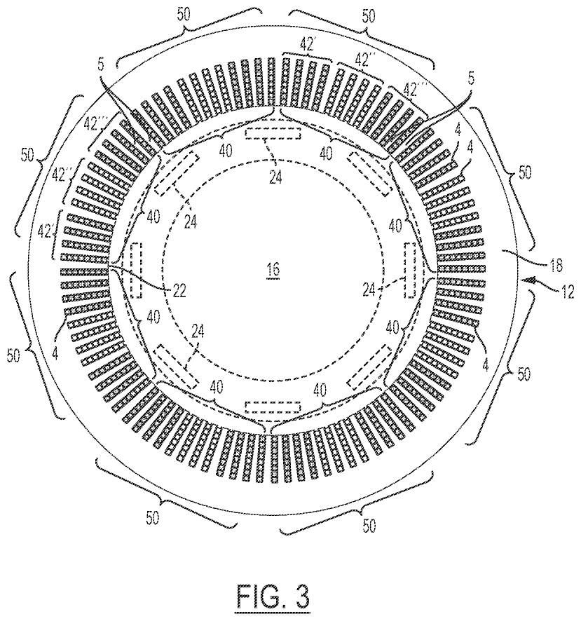

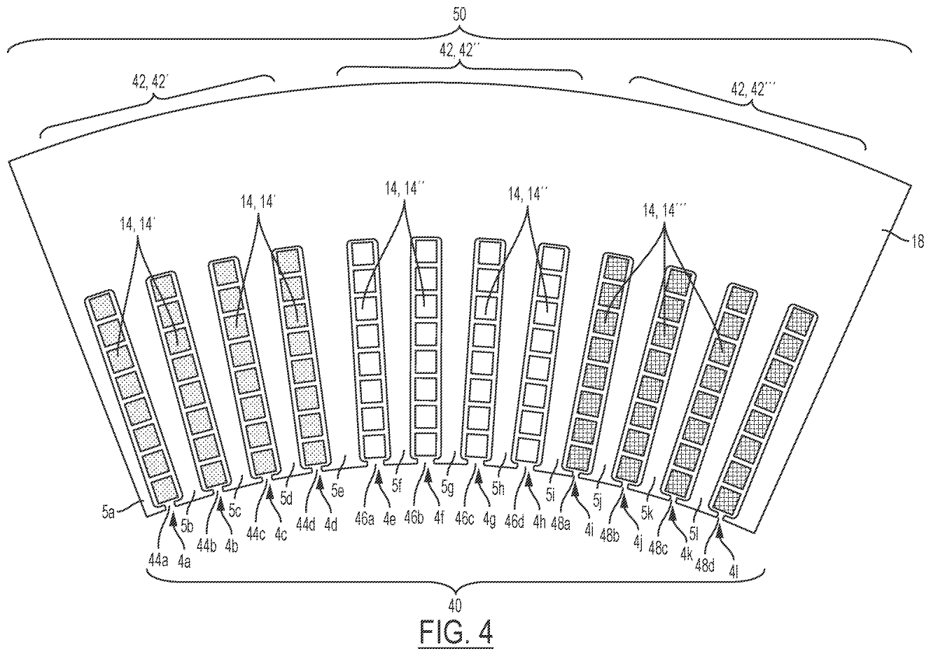

Referring now to FIG. 2, a front view of an example, non-limiting stator and rotor are shown for an electric machine/motor 10 according to the present disclosure. The coils 14 dedicated to the different phases used in the elector machine/motor 10 are disposed within the slots (element 4 in FIGS. 3 and 4), FIG. 3 is a schematic top view of a permanent magnet rotating electric machine 10 configured as an example of the rotating electric machine 10 according to the present invention. This permanent magnet rotating electric machine 10 may be used as the rotating electric machine 200 or the rotating electric machine 202 in the hybrid vehicle (see FIG. 1 and FIG. 2) described above. It is to be noted that as explained later, the structure of the rotating electric machine according to the present invention may be adopted in a synchronous reluctance motor or an induction motor instead of a permanent magnet rotating electric machine.

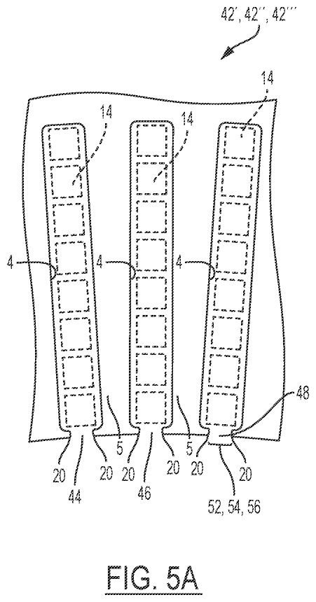

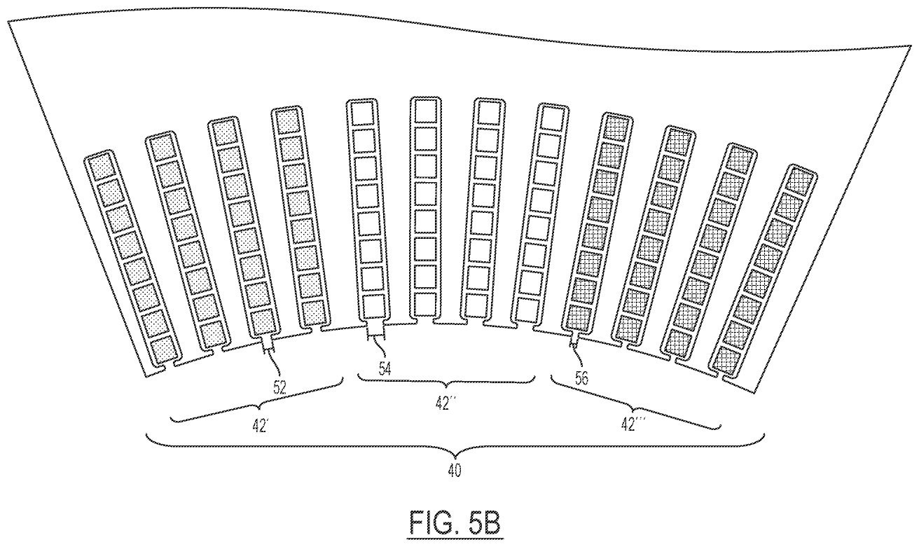

As shown in FIG. 2, cons 14 are wound at the teeth 5 of the stator 12 through a distributed winding as described below. With reference to FIG. 3, a non-limiting example top schematic view of the rotating electric 10 machine is shown according to the present invention. The rotating electric machine 10 shown in FIG. 3 represents a non-limiting example where the present invention is adopted in a three-phase permanent magnet rotating electric machine 10 with eight poles and 96 slots. It is understood however that the present disclosure contemplates an electric motor/machine 10 with any number of phase (not limited to a three-phase element motor as illustrated). Each group of teeth 50 (tooth group 50) may be made up with m (=12) teeth, with m representing the quotient calculated by dividing the number S (=96) of slots at the stator by the greatest common divisor N (=8) of the number of poles P and the number of stator slots S, or with d (=4) teeth, with d representing a divisor of m. All of the stator slots 4 are divided into slot groups 40 wherein each slot group 40 contains a plurality of slot subgroups 42 as later described herein. The slot opening widths (see elements 52, 54, 56 in FIG. 4) are fixed within each subgroup 42′, 42″, 42′″—also as later described herein. As shown in FIG. 3, slots 4 with openings 44a-44d, 46a-46d, 48a-48d within each slot group 40 (see FIG. 4) are defined along the inner circumference 22 of the stator 12. However, in the example shown in FIG. 5B, the first, second and third opening widths 52, 54, 56 of first, second and third subgroups respectively 42′, 42″, 42′″ (while different from each other) each fall within the range of about 0.55 mm to about 1.1 mm for each slot opening width. As shown in the non-limiting example of FIG. 4, each first subgroup 42′ in each slot group 40 in the stator 12 (see FIG. 4) is dedicated to first phase windings/coils 14′, each second subgroup 42″ is dedicated to second phase windings 14″, and each third subgroup 42′″ is dedicated to third phase windings/coils 14′″. Accordingly, the slot opening widths 44, 46, 48 for each subgroup vary relative to one another.

FIG. 4 illustrates twelve teeth 5a to 51 forming the non-limiting example tooth group 50 for stator 12 in FIG. 2. FIG. 4 and FIG. 5B also illustrates examples of slot opening widths 52, 54, 56 which may be assumed at twelve slots 4a to 4l making up an example slot group 40. It is to be noted that unless specifically noted, a given tooth or slot will be simply referred to as a tooth 5 or a slot 4. Any given slot subgroup may simply be referred to as slot subgroup 42. It is also to be noted that reference numeral 24 in FIG. 3 indicates a permanent magnet 24 which are disposed on the rotor 16.

FIG. 4 shows the twelve teeth 5a through 51 included in one tooth group 50. At a stator core 18 shown in FIG. 3, the arrangement of the twelve teeth 5a through 51 (tooth group 50) in FIG. 4 are iterated cyclically along the inner circumference 22 of the stator 12 so that there are eight tooth groups 50 which are set along the circumferential direction. It is to be noted that FIG. 3 does not include the detail regarding the shapes and width openings for the tooth tips 20 (see FIG. 5). Rather, FIGS. 4 and 5 illustrates example, non-limiting detail for the tooth tips 20 and slots.

Furthermore, in the non-limiting example of a three-phase electric machine 10 in FIGS. 3 and 4, each slot group 40 in the stator 12 may be formed with twelve slots 4a through 4l corresponding to the twelve teeth 5a through 51 making up each tooth group 50 in FIGS. 3 and 4. In the non-limiting example provided in FIGS. 3 and 4, the slot group 40 further includes slot subgroups 42 each made up with 4 slots. It is understood that each slot subgroup 42 may be made up with a different number of slots 4 such as, but not limited to four slots. However, the slot subgroups 42 may be formed from any number of slots.

The openings at the individual slots 4 are formed so that each slot 4a-4d for a first slot subgroup 42′ has a first slot opening (44a, 44b, 44c, 44d respectively shown in FIG. 4) wherein each slot 4a-4d has a first slot opening width 52 (see FIG. 5B). Similarly, each slot 4e-4h for a second slot subgroup 42″ has a second slot opening (46a, 46b, 46c, 46d respectively in FIG. 4) which are fixed wherein each slot in the second slot subgroup 42″ has a second slot opening width 54 (see FIG. 5B), and each slot 4i-41 in the third slot subgroup 42′″ for has a third slot opening (48a, 48b, 48c, 48d respectively) wherein each slot 4i-4l has a third slot opening width 56 (see FIG. 5B). However, the slot opening widths 52, 54, 56 are not equal to each other. (The first, second and third subgroups 42′, 42″, 42′″ correspondingly dedicated to the first; second and third phases respectively.) Accordingly, the slot-openings widths 52, 54, 56 vary from subgroup 42 (phase) to any adjacent subgroup 42 (phase) within the stator 12 as shown in FIG. 5B such that this arrangement reduces the radial magnetic force of the winding order emanating from the motor 10. For the sake of clarity, it is understood that, in the example provided in FIG. 4, slot subgroups 42 are each respectively made up with the slots 4a through 4d, the slots 4e through 4h, or the slots 4i through 4l. In the non-limiting example of FIG. 4 using a three-phase electric motor 10, the first slot subgroup 42′ is formed by slots 4a through 4d. The second slot subgroup 42″ is formed by slots 4e through 4h and the third slot subgroup 42′″ is formed by slots 4i through 4l.

The present arrangement of “phase specific” slot opening widths 52, 54, 56 significantly attenuates the winding order of vibration—24^{th} order in this non-limiting example of an 8-pole and 3 phase electric motor/machine 10, as shown in the data provided below. However, motor performance like torque is negligibly affected by this design arrangement.

Stator Mount Force, dB

| Stator | 24 Order | 48Order | 72Order | 96Order |
|---|---|---|---|---|
| Regular | 63.00 | 45.80 | 45.43 | 51.02 |
| Modified | 59.25 | 42.97 | 33.90 | 52.21 |

As shown in FIG. 4, the slot opening widths 52, 54, 56 may vary from one slot subgroup 42 (dedicated to a first phase for example) to an adjacent slot subgroup 42 (dedicated to a second phase in the present example) by as little as approximately ±0.05 mm or may vary by as much as ±0.50 mm. It is understood that the slot opening widths 52, 54, 56 for the various slot subgroups 42 may progressively increase (or decrease) as one moves from a first slot subgroup 42′ to an adjacent second slot subgroup 42″ and then to the next adjacent subgroup 42′″ (using the illustrated non-limiting example of a 3 phase motor), Alternatively, it is also understood that the slot openings widths 52, 54, 56 for the semi-open slots may also simply vary (not necessarily progressively increase or decrease) as one moves from the first slot subgroup 42′ to the adjacent second subgroup 42″, and then to the next adjacent subgroup 42′″—in this example, a third slot subgroup 42′″ (dedicated to a third phase) in the illustrated three phase motor.

Accordingly, the present disclosure provides a rotating electric machine/motor 10 which attenuates noise and vibration from the stator 12 wherein the noise/vibration is generated by magnetic radial forces. The electric machine 10 includes a stator 12 and a rotor 16 disposed within the stator 12. The stator 12 defines a plurality of teeth 5 and a plurality of semi-open slots 4. The plurality of semi-open slots 4 further is formed by plurality of slot groups 40 wherein each slot group 40 further includes a plurality of slot subgroups 42. As shown in FIG. 5B, each slot group 40 includes at least a first subgroup 42′ of slots having a first slot opening width 52 and being dedicated to a first phase, and a second subgroup 42″ of slots having a second slot opening width 54 and being dedicated to a second phase, the second slot opening width 54 being different from the first slot opening width 52. The second subgroup 42″ of slots may be disposed adjacent to the first subgroup 42′ of slots. Each first slot opening width 52 in the first slot subgroup may vary from each second slot opening width 54 in the second subgroup by as little as 0.05 mm to as much as 0.5 mm. The first slot opening width 52 is defined between a pair of first subgroup tooth tips which partially extend over a first subgroup slot opening, and the second opening width is defined between a pair of second subgroup tooth tips which partially extend over a second subgroup slot opening.

In the event the rotating electric machine 10 is a three-phase motor, each slot group 40 defined in the stator 10 may further include a third subgroup 42′″ (FIGS. 4 and 5B) of slots adjacent to the second subgroup 42″ of slots wherein each slot 4 in the third subgroup 42′″ of slots has a third slot opening width 56. As shown in FIG. 5B, the slot opening width 52, 54, 56 for the corresponding subgroup 42′, 42″, 42′″ is defined between each pair of tooth tips 20 which partially extend over the slot opening (44a-d, 46a-46d, 48a-48d in FIG. 4) to the slot 4. The third slot opening width 56 is different from each of the first and second slot opening widths 52, 54. Therefore, the first slot opening width 52, the second slot opening width 54 and the third slot opening width 56 may vary in one phase relative to the adjacent phase by as little as ±0.05 mm to as much as ±0.5 mm. In the non-limiting example provided in FIGS. 3-5B, the first, second and third slot opening widths 52, 54, 56 (while different from each other) may, but not necessarily fall within a range of 0.5 mm to 1.1 mm.

Noting that the electric machine 10 of the present disclosure may have any number of phases, it is understood that regardless of the number of phases each tooth 5 in the plurality of teeth 5 defines a pair of tooth tips 20 as shown in FIG. 5A wherein each tooth tip 20 extends over an adjacent corresponding slot 4. Moreover, the plurality of slot groups 40 is formed along an inner circumference 22 of the stator 12. Each slot group 40 in the plurality of slot groups 40 is configured to support a plurality of phase coil windings 14.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A rotating electric machine, comprising:
a stator that defines a plurality of teeth and a plurality of semi-open slots; and
a rotor configured to rotate within the stator;
wherein the plurality of semi-open slots is further formed by a plurality of slot groups, each slot group further includes a plurality of slot subgroups wherein each slot group includes a first subgroup of slots dedicated to a first phase and having a first slot opening width defined at each slot in the first subgroup, and a second subgroup of slots adjacent to the first subgroup of slots, the second subgroup of slots being dedicated to a second phase and having a second slot opening width defined at each slot in the second subgroup, the second slot opening width being different from the first slot opening width.

2. The rotating electric machine as defined in claim 1 wherein each slot group further includes a third subgroup of slots having a third slot opening width wherein the third slot opening width is different from each of the first and second slot opening widths.

3. The rotating electric machine as defined in claim 1 wherein the first slot opening width may vary from the second slot opening width by as little as 0.05 mm to as much as 0.5 mm.

4. The rotating electric machine as defined in claim 2 wherein the first slot opening width, the second slot opening width and the third slot opening width may vary from each other by as little as 0.05 mm to as much as 0.5 mm.

5. The rotating electric machine as defined in claim 3 wherein each tooth in the plurality of teeth defines a pair of tooth tips wherein each tooth tip extends over an adjacent corresponding slot.

6. The rotating electric machine as defined in claim 4 wherein each tooth in the plurality of teeth defines a pair of tooth tips wherein each tooth tip extends over an adjacent corresponding slot.

7. The rotating electric machine as defined in claim 5 wherein the first opening width is defined between a pair of first subgroup tooth tips which partially extend over a first subgroup slot opening, and the second opening width is defined between a pair of second subgroup tooth tips which partially extend over a second subgroup slot opening.

8. The rotating electric machine as defined in claim 6 wherein the third opening width is defined between a pair of third subgroup tooth tips which partially extend over a third subgroup slot opening.

9. The rotating electric machine defined in claim 7 wherein the plurality of slot groups is formed along an inner circumference of the stator.

10. The rotating electric machine as defined in claim 8 wherein the plurality of slot groups is formed along an inner circumference of the stator.

11. The rotating electric machine as defined in claim 9 wherein each slot group in the plurality of slot groups are configured to support a plurality of phase windings.

12. The rotating electric machine as defined in claim 10 wherein each slot group in the plurality of slot groups are configured to support a plurality of phase windings.
